(19) United States
(12) Patent Application Publication
(10) Pub. No.: US 2010/0239999 A1
(43) Pub. Date: Sep. 23, 2010

(54) MULTI-FREQUENCY APEX LOCATOR

(76) Inventor: Haim Rozenboim, Natania (IL)

Correspondence Address: MARTIN D. MOYNIHAN d/b/a PRTSI, INC., P.O. BOX 16446, ARLINGTON, VA, 22215, US

(21) Appl. No.: 12/664,920

(22) PCT Filed: Jun. 21, 2007
(86) PCT No.: PCT/IL07/00755

§ 371 Date: Jun. 6, 2010

(51) Int. Cl. A61C 19/04

(52) U.S. Cl. 433/32; 433/215

(57) ABSTRACT

A method of measuring the distance of a probe in a cavity in a root canal of a tooth, comprising:
supplying at least one first voltage waveform to the probe via a resistor;
receiving at least one signal responsive to the position of the probe and the at least one first voltage waveform;
generating two response waveforms from said at least one signal, at least one of said response waveforms having at least a primary frequency component and a substantial amount of at least one other non-zero frequency component; and
estimating the distance of the probe from the apex utilizing both generated waveforms.

### FIELD OF THE INVENTION

The present invention relates to a apparatus and methods of determining the distance of a probe from the apex of a root during a root canal procedure.

### BACKGROUND OF THE INVENTION

In root canal therapy, the interior of a root is removed prior to filling the root with replacement material. If the canal is not completely emptied of the root material prior to filling with the replacement material, leftover root material can retard healing and even act as a focus for infection. For this reason, all of the natural interior material in the root is removed before filling.

It is conventional, in order to tell is there is more natural material in the root, insert a probe into the excavated root canal and to determine how far the probe is from the apex of the root.

It is noted that while the removal of the natural root material is a surgical procedure, the determination of the distance of the probe from the apex (hereinafter, “apex location”) is not a surgical procedure, since no cutting or insertion into a closed region of the body is performed.

U.S. Pat. No. 5,017,134, the disclosure of which is incorporated herein by reference, describes locating the apex by measuring the impedance between the probe and a probe in touching the gums at 1 and 5 KHz. The difference between the impedances is used to determine when the apex is reached.

U.S. Pat. No. 5,080,586, the disclosure of which is incorporated herein by reference, shows a prior art system in FIG. 1 (JP laid open application 174144/85) locating the apex by electrification of the probe with a sequentially applied pulses at two different frequencies and measuring a current flowing between the probe and an electrode at the gum of the patient. The measured current is filtered to provide only the fundamental frequency to the apex location determination circuit. The changes in the two filtered signals is compared as the probe moves along and changes in the current values are used to determine the apex location. This current is measured by measuring the voltage on a resistor situated between the gum electrode and ground.

In the disclosure of the '586 patent, the apex is located utilizing a difference between the two signals to determine the position of the apex.

U.S. Pat. No. 5,096,419, the disclosure of which is incorporated herein by reference, discloses locating the apex by electrification of the probe with sequentially applied sinusoidal signals at two different frequencies. The patent claims that the impedance of the tooth is measured. However, what is disclosed is measuring a current flowing between the probe and an electrode at the gum of the patient. This current is measured by measuring the voltage on a non-negligible resistor situated between the gum electrode and ground. The ratio of the measured currents is apparently used to locate the apex.

U.S. Pat. No. 6,425,875, the disclosure of which is incorporated herein by reference, is similar to the prior art cited above in that it uses measurements at two sinusoidal frequencies. For certain regions it uses the difference between the measurements and at others it uses the ratio between them.

U.S. Pat. No. 6,221,031, the disclosure of which is incorporated herein by reference, describes a system in which a pulsed electrical signal is applied to the probe and the response measured. Two points on the response are measured and the ratio between the points is used to determine the distance to the apex.

U.S. Patent Publication 2004/0285234, the disclosure of which is incorporated herein by reference, describes a system in which the impedance (or a component of the impedance) is measured and compared to values in a look-up table. No method appears to be given for determining the impedance values.

U.S. Patent Publication 2006/0184061, the disclosure of which is incorporated herein by reference, describes a system in which the tooth is electrified by pulses having two different active times. The apex position is determined by comparing a function of the power of the response to these pulses to values in a look-up table.

### SUMMARY OF THE INVENTION

An aspect of some embodiments of the invention is the provision of a method and apparatus using a response to at least one multi-frequency voltage waveform to determine the distance of a probe from the apex of the root of a tooth.

In some embodiments of the invention, the at least one multi-frequency voltage waveform comprises at least two pulsed voltage waveforms having different multi-frequency spectra.

In an embodiment of the invention the multi-frequency waveforms are applied to the tooth to produce two or more response signals. The two or more response signals are sampled and the values of the samples (or the value of the square of the samples) is summed for each response. The sums of the measured values (or the squares of the measured values) are then compared and the comparison is used in determining the position of the probe. Various embodiments of the invention compare the sums by forming one or more of a sum or ratio of the sums.

In some embodiments of the invention at least some of the measured signals are filtered to remove reduce and/or enhance the relative values of the spectral components. In this embodiment of the invention, this results in significant higher or lower frequency spectral components (either individually or taken together) in at least one of the filtered measured signal having an amplitude of least 10%, 20%, 30% or greater than the spectral amplitude of the primary or fundamental frequency of the pulsed signal.

In some embodiments of the invention only a single multi-frequency voltage waveform is applied. The resultant response signal is filtered to generate two waveforms, each with a different frequency spectrum. At least one of the waveforms has a significant amount of at least two non-DC frequency spectral components.

At least some embodiments of the invention have improved characteristics, such as improved linearity and/or accuracy as compared to prior art methods that utilize only a single spectral component. Such single spectral methods generally compute one or more impedance values and compare those values (or a sum or ratio of the values) with values in a look-up table. It should be understood that when multi-frequency signals are sampled and summed, the values of the impedance is irrecoverably lost.

In some embodiments of the invention the duty cycle of the pulsed signal is less than 30%, less than 20% or even less than 10%. As taught in the above referenced U.S. Patent Publication 2006/0184061, this allows for using a higher peak power than would be possible if a continuous signal such as a sinusoidal signal or a pulses signal with a 50% duty cycle were used. Various examples of useful pulsed signals are given in the detailed description below.

In some embodiments of the invention, the measured signal is sampled only in a region in which there is expected to be a response to the excitation. The un-sampled positions are assumed to be zero or the un-sampled region is assumed not to exist, such that the pseudo-spectrum that is utilized is similar to that of a signal with a higher duty cycle.

In some embodiments of the invention, the system is greatly simplified by utilizing a first signal having a first active period and having a second signal having a second active period much lower than that of the first active period. If a number of pulses of the second signal are present during a period equal to that of the first signal, the same sampling regime can be used for both signals.

There is thus provided, in accordance with an embodiment of the invention, a method of measuring the distance of a probe in a cavity in a root canal of a tooth, comprising:

supplying at least one first voltage waveform to the probe via a resistor;

receiving at least one signal responsive to the position of the probe and the at least one first voltage waveform;

generating two response waveforms from said at least one signal, at least one of said response waveforms having at least a fundamental frequency component and a substantial amount of at least one other non-DC frequency component; and

estimating the distance of the probe from the apex utilizing both generated waveforms.

In an embodiment of the invention, the at least one first voltage waveform comprises first and second voltage waveforms applied sequentially, wherein said at least one signal comprises first and second signals responsive to the first and second waveforms respectively.

Optionally, the at least one first voltage waveform comprises a voltage having a plurality of distinct frequency components.

In an embodiment of the invention, the at least one first voltage waveform comprises one or more voltage pulses. Optionally, the at least one first voltage wave form has a duty cycle of less than 30%.

In an embodiment of the invention the at least one signal comprises a voltage between the probe and an electrode contacting soft tissue in the mouth.

Optionally, both of the response waveforms have at least a primary frequency component and a substantial amount of at least one other non-DC frequency component, where the primary frequency is different for the two waveforms.

Optionally, the at least one other non-DC frequency component has an amplitude at least 10%, 20%, 30% or 40% of that of the primary frequency component.

Optionally, estimating comprises:

deriving a characteristic value from each of the two response waveforms; and

estimating the distance of the probe from the apex utilizing the derived characteristics values of both response waveforms.

Optionally, deriving a characteristic value of each of the two response waveforms comprises:

sampling the each of the response waveforms; and

summing the amplitude of the samples.

Alternatively, deriving a characteristic value of each of the two response waveforms comprises:

sampling the each of the response waveforms; and

summing the square of the amplitude of the samples.

Optionally, deriving a characteristic value comprises filtering one or both of the two response waveforms.

Optionally, filtering comprises removing a DC component.

Optionally, filtering comprises reducing the amplitude of one or more frequency components of the respective response waveform.

Optionally, filtering comprises decreasing the amplitude of the primary such that the relative amplitude of one or more other non-DC harmonics is increased when compared to that of the primary.

Optionally, estimating comprises:

comparing the two characteristic values to provide an indicative value.

Optionally, comparing comprises finding a difference between the two characteristic values. Alternatively or additionally, comparing comprises finding a ratio between the two characteristic values.

In an embodiment of the invention, estimating comprises comparing the indicative value to values derived from actual measurements on patients.

Alternatively, estimating comprises comparing the indicative value to values derived from a theoretical analysis.

Optionally, at least some of the other non-DC spectral components are at a higher frequency than the primary frequency.

There is further provided, in accordance with an embodiment of the invention, apparatus for measuring the distance of a probe in a cavity in a root canal of a tooth, comprising:

a probe for insertion into a tooth;

an electrode for touching a soft tissue in the mouth;

a power supply supplying at least one first voltage waveform to the probe via a resistor;

a controller that is operative to
receive the at least one signal responsive to the position of the probe and the at least one first voltage waveform;
generate two response waveforms from said at least one signal, at least one of said response waveforms having at least a primary frequency component and a substantial amount of at least one other non-DC frequency component; and
estimate the distance of the probe from the apex utilizing both generated waveforms.

In an embodiment of the invention, the at least one first voltage waveform comprises first and second voltage waveforms applied sequentially, wherein said at least one signal comprises first and second signals responsive to the first and second waveforms respectively.

Optionally, the at least one first voltage waveform comprises a voltage having a plurality of distinct frequency components.

In an embodiment of the invention, the at least one first voltage waveform comprises one or more voltage pulses. Optionally, the at least one first voltage wave form has a duty cycle of less than 30%.

In an embodiment of the invention the at least one signal comprises a voltage between the probe and the electrode.

Optionally, both of the response waveforms have at least a primary frequency component and a substantial amount of at least one other non-DC frequency component, where the primary frequency is different for the two waveforms.

Optionally, the at least one other non-DC frequency component has an amplitude at least 10%, 20%, 30% or 40% of that of the primary frequency component.

Optionally, the controller is operative to:

derive a characteristic value from each of the two response waveforms; and

estimate the distance of the probe from the apex utilizing the derived characteristics values of both response waveforms.

Optionally, the controller is operative to derive the characteristic value of each of the two response waveforms by:

sampling the each of the response waveforms; and

summing the amplitude of the samples.

Optionally, the controller is operative to derive the characteristic value of each of the two response waveforms by:

sampling the each of the response waveforms; and

summing the square of the amplitude of the samples.

Optionally, the apparatus includes a filter that filters one or both of the two response waveforms.

Optionally, filtering comprises removing a DC component. Optionally, filtering comprises reducing the amplitude of one or more frequency components of the respective response waveform. Optionally, filtering comprises decreasing the amplitude of the primary such that the relative amplitude of one or more other non-DC harmonics is increased when compared to that of the primary.

In an embodiment of the invention, the controller is operative to:

compare the two characteristic values to provide an indicative value.

Optionally, comparing comprises finding a difference between the two characteristic values.

Optionally, comparing comprises finding a ratio between the two characteristic values.

Optionally estimating comprises comparing the indicative value to values derived from actual measurements on patients.

Optionally. estimating comprises comparing the indicative value to values derived from a theoretical analysis.

### BRIEF DESCRIPTION OF THE DRAWINGS

The subject matter regarded is particularly and distinctly claimed in the concluding portion of the specification. Non-limiting examples of embodiments of the present invention are described below with reference to figures attached hereto, which are listed following this paragraph. In the figures, identical structures, elements or parts that appear in more than one figure are generally labeled with a same symbol in all the figures in which they appear. Dimensions of components and features shown in the figures are chosen for convenience and clarity of presentation and are not necessarily shown to scale. For example, the dimensions of some of the elements may be exaggerated relative to other elements for clarity.

FIG. 1 is an exemplary simplified diagram of a apex measuring system in accordance with some embodiments of the present invention;

FIG. 2 is a block diagram of a method of determining the apex position of a probe, in accordance with an exemplary embodiment of the invention;

FIGS. 3A and 3B show respectively an exemplary excitatory first electrical signal according to some embodiments of the present invention, and a spectrum of this signal;

FIG. 3C is a spectrum derived from the first excitatory signal and utilizing a shortened sampling scheme for determining the spectrum;

FIGS. 4A and 4B show respectively an exemplary second excitatory electrical signal according to some embodiments of the present invention, and a spectrum of this signal;

FIGS. 5A and 5B show respectively an alternative exemplary second excitatory electrical signal according to some embodiments of the present invention, and a spectrum of this signal;

FIGS. 6A and 6B show respectively an exemplary measured response to the signal of FIG. 3A, and a spectrum of this signal;

FIGS. 7A and 7B show respectively an exemplary measured response to the signal of FIG. 4A, and a spectrum of this signal;

FIGS. 8A and 8B show respectively an exemplary measured response to the signal of FIG. 5A, and a spectrum of this signal;

FIGS. 9A, 9B and 9C show typical spectra after filtering used to determine the apex location; and

FIG. 10 shows the elements of an exemplary look-up table comparing the apex distance of a probe and a computed value according to an exemplary embodiment of the invention.

It will be appreciated that for simplicity and clarity of illustration, elements shown in the figures have not necessarily been drawn to scale. Further, where considered appropriate, reference numerals may be repeated among the figures to indicate corresponding or analogous elements.

### DETAILED DESCRIPTION OF EXEMPLARY EMBODIMENTS

In the following description, exemplary, non-limiting embodiments of the invention incorporating various aspects of the present invention are described. For purposes of explanation, specific configurations and details are set forth in order to provide a thorough understanding of the embodiments. However, it will also be apparent to one skilled in the art that the present invention may be practiced without the specific details presented herein. Furthermore, well-known features may be omitted or simplified in order not to obscure the present invention. Features shown in one embodiment may be combined with features shown in other embodiments. Such features are not repeated for clarity of presentation. Furthermore, some unessential features are described in some embodiments.

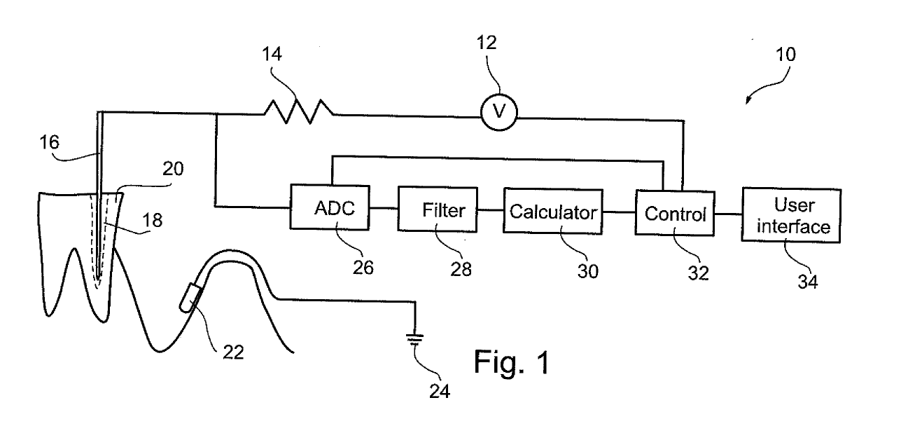

Reference is now made to FIG. 1 showing an exemplary simplified block diagram of a system 10 for measurement of the distance of a probe from the apex of a root of a tooth. System 10 comprises a voltage generator 12 having an output impedance 14 which feeds a probe 16 placed in the root canal 18 of a tooth 20 whose root is being cleared of material prior to filling with filler material. An electrode 22 touches the gum or other tissue in the mouth (touching the lip is shown) and is connected to ground 24. In exemplary embodiments, the voltage generator generates pulsed voltage waveforms. In general, all voltages described herein are with respect to ground.

An analog to digital converter (ADC) 26 receives a signal from probe 16 and samples and digitizes the signal. An optional filter 28 filters the signal and sends it to calculator 30 which processes the digitized and optionally filtered signals and determines the distance from the apex based on the signals.

A controller 32 receives the calculations and provides an indication of the distance to a user interface 34. Controller 32 also controls and synchronizes pulse generator 12 and the other electronics. All or some of the electronics can be conveniently provided as an ASIC. Alternatively or additionally, the filtering and calculation functions can be performed by the controller. Furthermore, while digital filtering is shown in FIG. 1, in some embodiments of the invention analog filtering can be used.

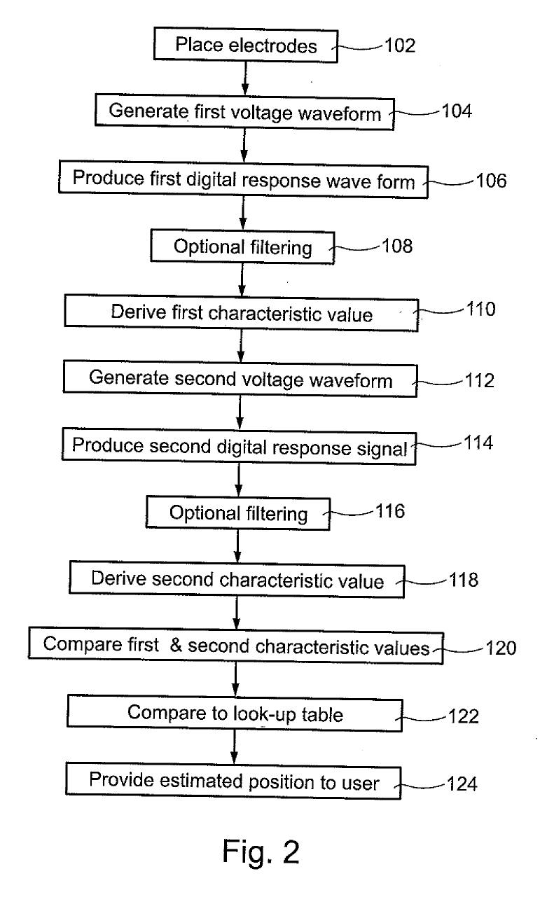

FIG. 2 is a simplified flow chart of a method 100 of determining the apex location of a probe, in accordance with an embodiment of the invention.

At 102, probe 16 is placed in root canal 18 and electrode 22 is placed in the mouth. In some embodiments of the invention, the probe is also used as a drill or reamer used to remove the material from the root canal. However, the material removal function does not form part of the present invention.

At 104, probe 16 is electrified by generating a first voltage waveform having a first multi-frequency spectrum.

At 106, the voltage induced between probe 16 and electrode 22 is measured, sampled and digitized to produce a first digital response waveform. In some embodiments of the invention, sampling is carried out over the entire cycle. Alternatively, sampling is carried out over only a more limited time, as described below.

At 108, the first digital signal is optionally filtered to remove one or more of the DC component and some or all of the higher frequencies in the first digital signal and/or to enhance the relative amounts of some higher order frequency components.

At 110, the first digital signal is processed to derive a first characteristic value of the first digital response signal. In an embodiment of the invention, the first characteristic value is the root mean square value of the first optionally filtered digital signal or its square.

At 112, probe 16 is electrified by generating a second voltage having a second multi-frequency spectrum, different from the first multi-frequency spectrum.

At 114, the voltage induced between probe 16 and electrode 22, by the second voltage is measured, sampled and digitized to provide a second digital response signal.

At 116, the first digital signal is optionally filtered to remove one or more of the DC component and some or all of the higher frequencies in the second digital signal and/or to enhance the relative amounts of some higher order frequency components.

At 118, the second digital signal is processed to derive a second characteristic value of the second digital response signal. In an embodiment of the invention, the second characteristic value is the root mean square value of the second optionally filtered digital signal or its square.

At 120, the first and second characteristic values are compared to provide a measure that indicates the position of the probe in the apex. This measure is compared 122 to a look-up table of values and an estimated position is provided 124 to a user. In an exemplary embodiment of the invention, the ratio of the characteristic values is used to provide the measure that indicates the position of the probe in the apex. In others it is the difference between the values.

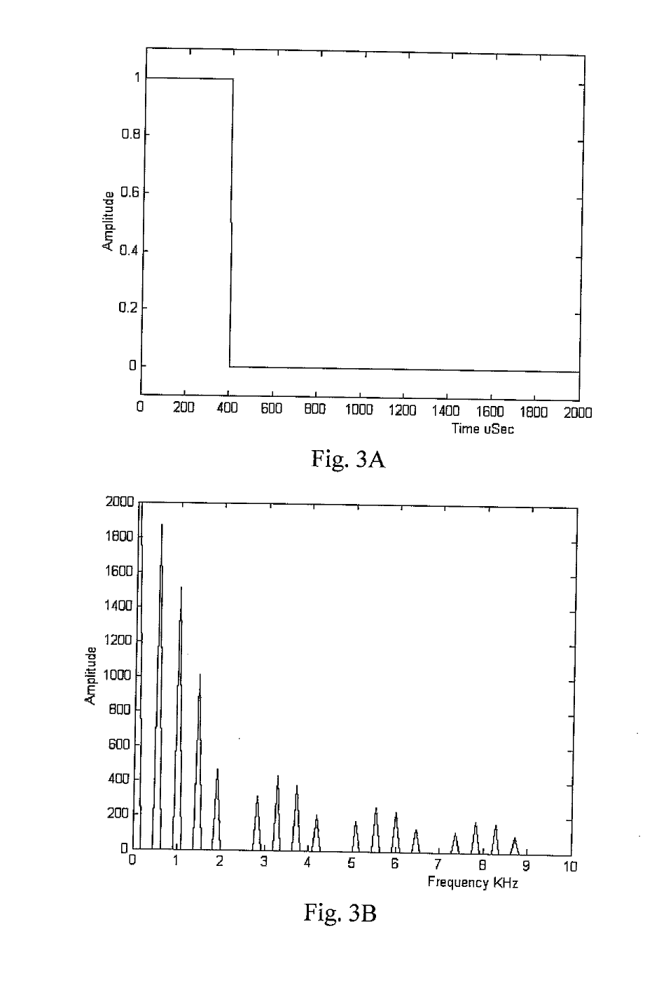

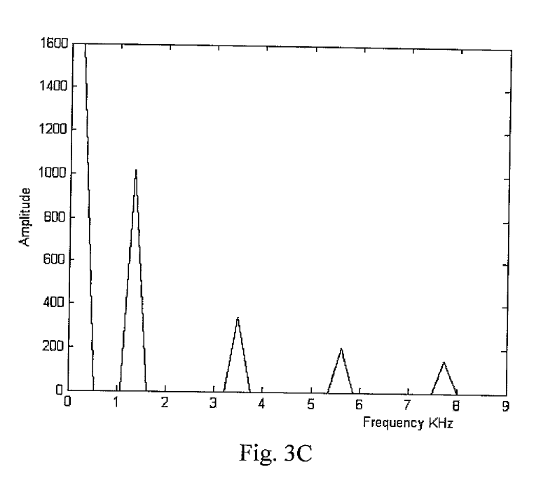

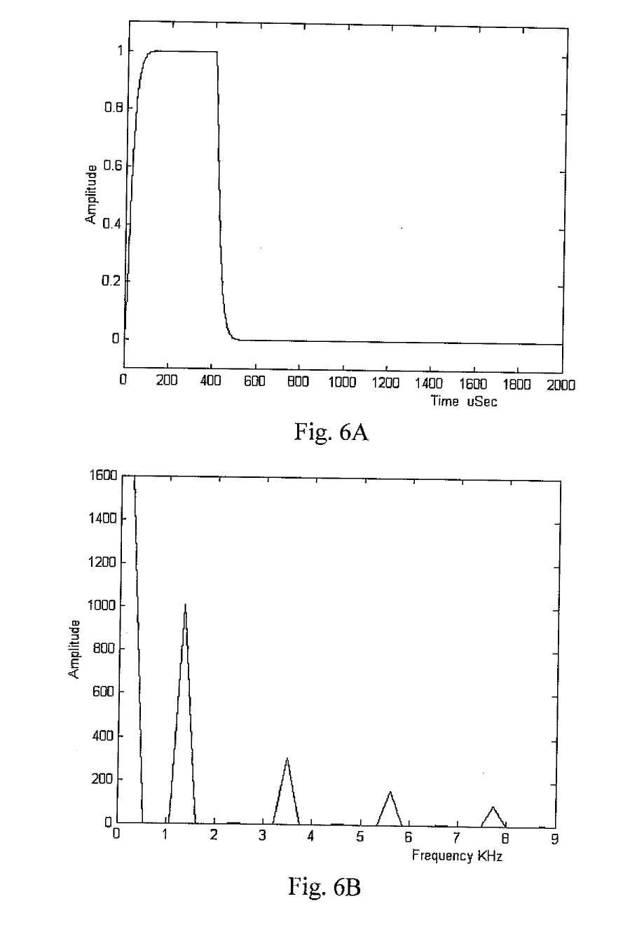

In some embodiments of the invention only a single excitatory voltage waveform is used. Filters are used to separate the resulting digital response waveform into two parts having different spectral components. Characteristic values for the two parts are defined as described above and below. This replaces blocks 104-118 of the flow chart of FIG. 2. The characteristic values are used to determine the position of the probe and provide information to the user. (Blocks 120-124 of FIG. 2) As can be seen from FIGS. 3B, 3C and 6B below there is sizable amplitude at many frequencies in both the input and response signals.

In exemplary embodiments of the invention at least a portion of the higher harmonics or other non-DC spectral components of one or both of the first and second digitized signals is not filtered out. Preferably, this results in non-primary spectral components (either individually or taken together) in at least one of the filtered measured signal having an amplitude of least 10%, 20%, 30%, 40% or greater than the spectral amplitude of the primary or fundamental frequency of the pulsed signal.

It should be understood that the sinusoidal components are not used individually in the practice of the preferred embodiments of the invention. The object of FIGS. 3-9 is to illustrate that the preferred embodiments of the invention find the characteristics of multi-frequency signals. Furthermore, it should be understood that the shape of the peaks in the frequency plots is not accurate and the peaks are probably very narrow. However, the output of the program used to calculate the spectrum outputs marrow spectral lines in this way so that they are more prominent.

In an exemplary embodiment of the invention, the voltage shown in FIG. 3A is used as the first voltage. Keeping in mind the expected electrical equivalent values of the tooth, between probe 16 and the electrode 22, the active time A of the signal of FIG. 3A is set to between 300 and 1000 microseconds, for example to 400 microseconds and the inactive time is set to between 3 and 20 or more times the active time, for example to 2 milliseconds. The spectrum of this signal is shown in FIG. 3B. The times listed are not generally critical and the inactive time is not critical at all. FIG. 3C shows a spectrum calculated by sampling only over a time of 800 microseconds. This is based on the fact that the signal during the off time of the pulse is zero and in practice is noise. The methodology used to determine the spectrum in FIG. 3C is used to determine the spectra for the rest of the plots.

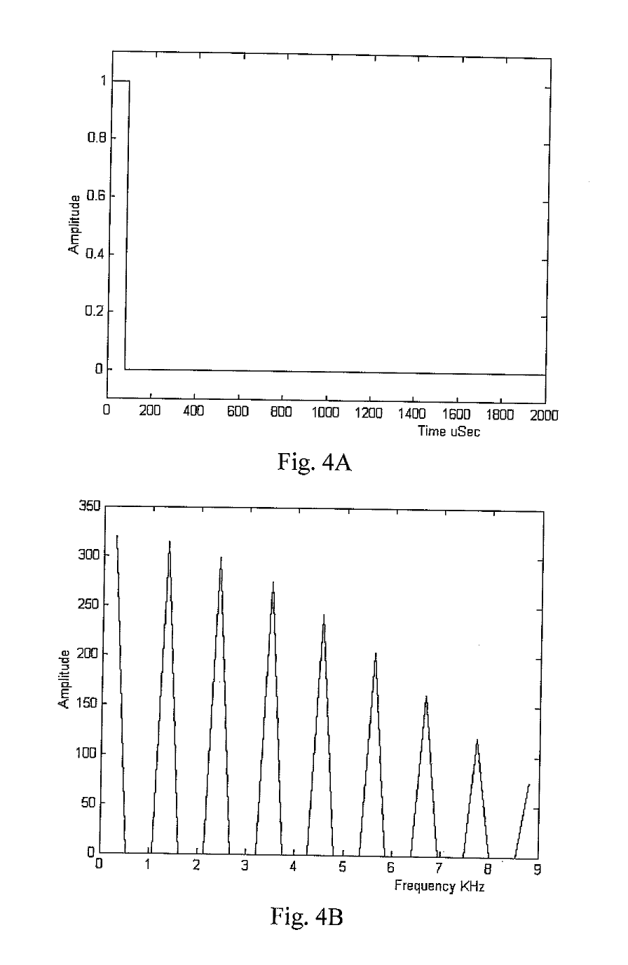

In an exemplary embodiment of the invention, the voltage shown in FIG. 4A is used as the second voltage. Keeping in mind the expected electrical equivalent values of the tooth, between probe 16 and the electrode 22, the active time A of the signal of FIG. 4A is set to between 60 and 120 microseconds, for example to 80 microseconds and the inactive time is preferably set to give a same repeat as the waveform of FIG. 3A.

In an embodiment of the invention, the signals of FIGS. 3A and 4A (or 5A if it is used) are repeated a number of times, until the output stabilizes. A convenient number of repeats is eight. The signal is then sampled and digitized by ADC 26.

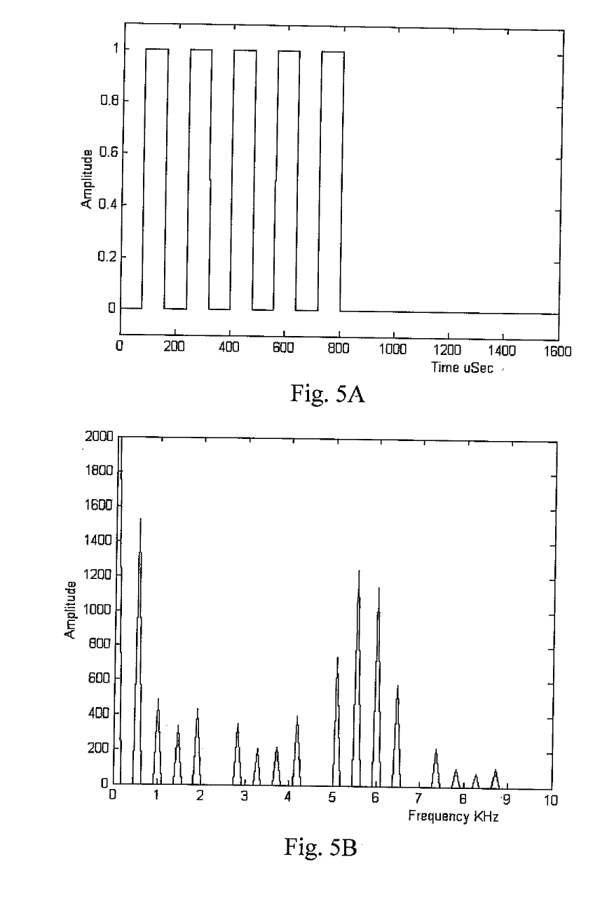

In an alternative exemplary embodiment of the invention, the voltage shown in FIG. 5A is used as the second voltage. Keeping in mind the expected electrical equivalent values of the tooth, between probe 16 and the electrode 22, the active time of each of the pulses of the signal of FIG. 5A is set to ¼ and 1/10 of the active time of signal of FIG. 3A. The number of pulses of the signal of FIG. 5A is not critical, but it is convenient to set the total length of the active and intervening inactive regions to about twice the active time of the signal of FIG. 3A, so that sampling as described above with respect to FIG. 3C can be easily carried out for all signals, using the same sampling scheme. The spectrum of the particular signal shown in FIG. 5A is shown in FIG. 5B.

FIG. 6A shows a typical voltage measured between a probe 16 and electrode 22 when the voltage of FIG. 3A is applied to the probe. The spectrum of this voltage is shown in FIG. 6B.

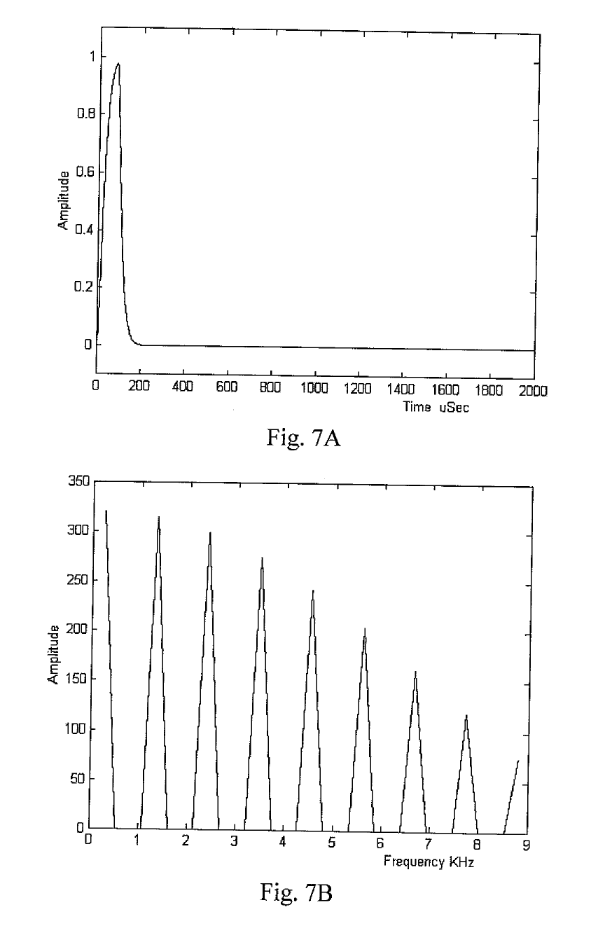

FIG. 7A shows a typical voltage measured between a probe 16 and electrode 22 when the voltage of FIG. 4A is applied to the probe. The spectrum of this voltage is shown in FIG. 7B.

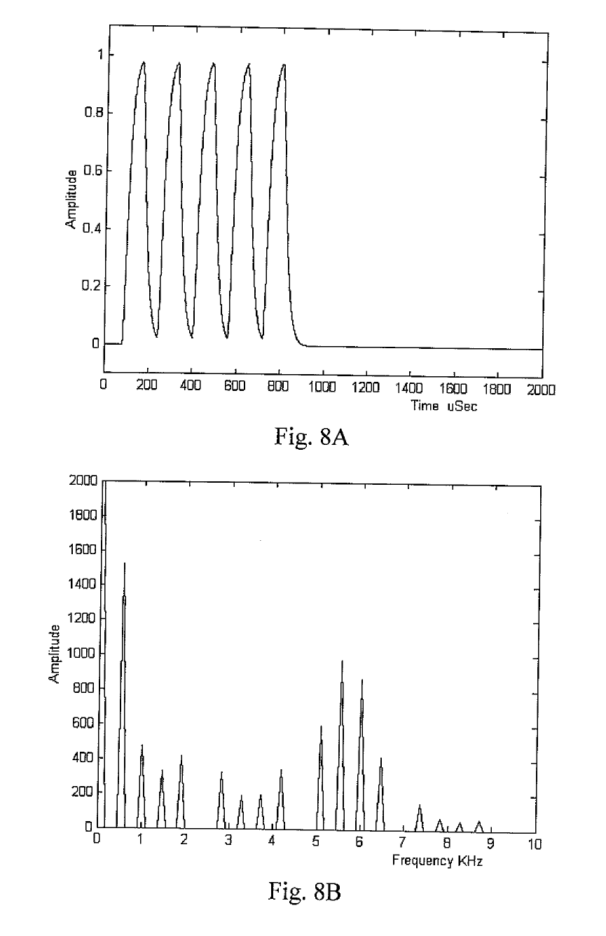

FIG. 8A shows a typical voltage measured between a probe 16 and electrode 22 when the voltage of FIG. 5A is applied to the probe. The spectrum of this voltage is shown in FIG. 8B.

As indicated above, the spectrum is optionally filtered.

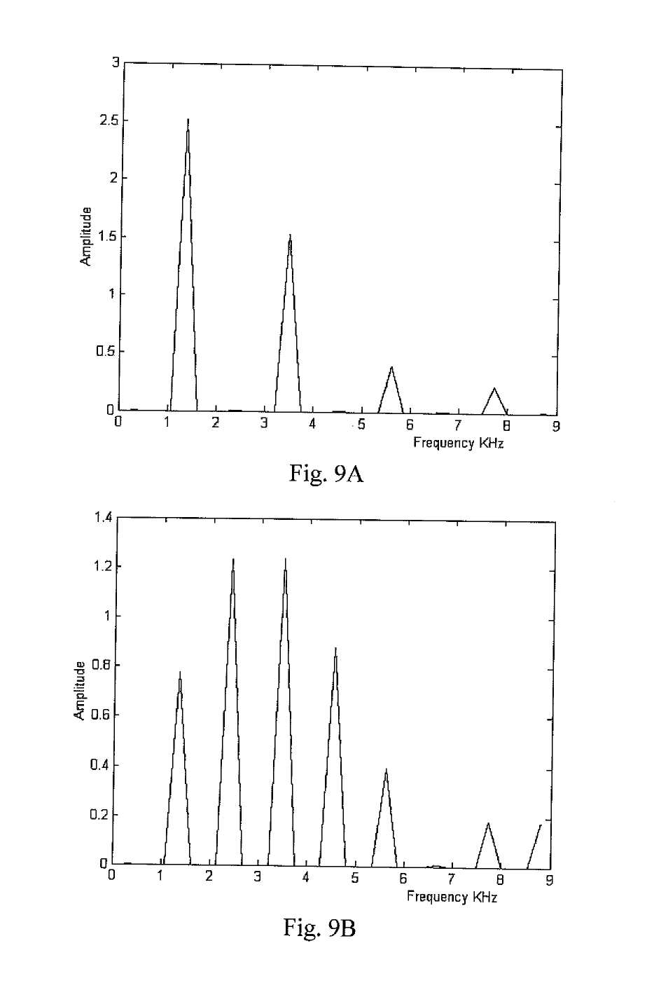

In an illustrative, exemplary embodiment of the invention, the digitized signals of FIGS. 6A, 7A and 8A (using the exemplary active times described above and shown in the Figs.) are filtered to provide the spectra shown if FIGS. 9A, 9B and 9C respectively. These samples in the filtered signals are squared and summed to form the above described characteristic values and the ratio of these values is computed. As indicated above, the frequency spectra are not utilized, per se.

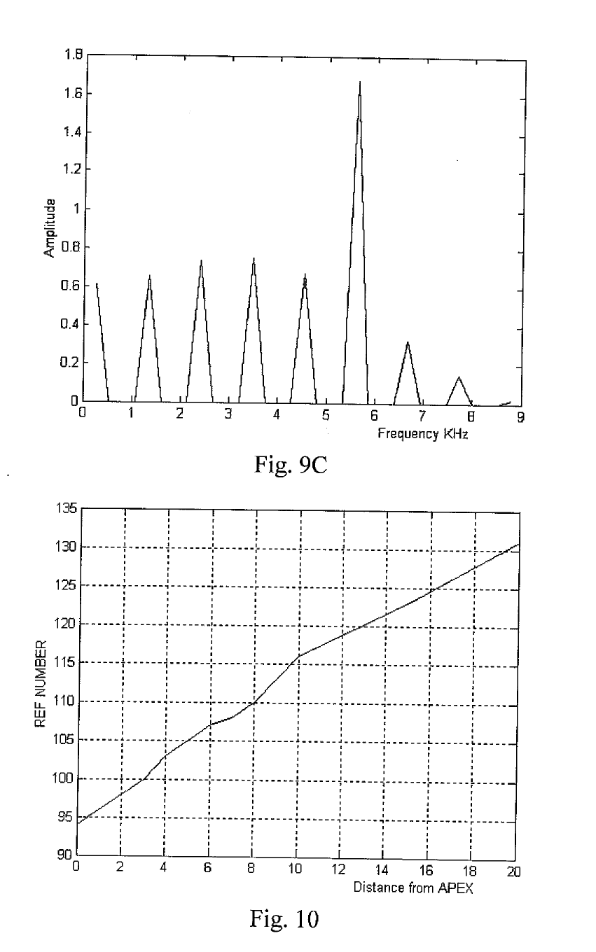

FIG. 10 shows a graph illustrative of a look-up table, derived from actual measurements, that shows the relationship between the ratio of values and the measured distance of the probe from the apex. It is seen that this graph is quite linear especially in the critical region, near the apex.

It should be further understood that the individual features described hereinabove can be combined in all possible combinations and sub-combinations to produce exemplary embodiments of the invention. Furthermore, not all elements described for each embodiment are essential. In many cases such elements are described so as to describe a best more for carrying out the invention or to form a logical bridge between the essential elements. The examples given above are exemplary in nature and are not intended to limit the scope of the invention which is defined solely by the following claims.

As used herein, the term primary or fundamental frequency means the non-DC spectral frequency having the largest amplitude of a signal as that signal is used to determine the apex location. In particular, for pulsed waveforms it is defined as the spectrum derived from samples taken over a period in which the voltage input to the tooth is non-zero for 50% of the time. Furthermore, it should be understood that while in general the other non-DC spectral components are higher frequencies of the primary or fundamental and may be harmonics of it, they may also be low frequency components, especially where the filtering enhances some of the frequencies.

The terms “include”, “comprise” and “have” and their conjugates as used herein mean “including but not necessarily limited to”.

1. A method of measuring the distance of a probe in a cavity in a root canal of a tooth, comprising:
supplying at least one voltage waveform to the probe via a resistor;
receiving at least one signal responsive to the position of the probe and the at least one first voltage waveform;
generating two response waveforms from said at least one signal, at least one of said response waveforms having at least a primary frequency component and a substantial amount of at least one other non-DC frequency component; and
estimating the distance of the probe from the apex utilizing both generated waveforms.

2. (canceled)

3. A method according to claim 1 wherein:
supplying comprises supplying at least one waveform comprises supplying first and second voltage waveforms;
receiving comprises receiving two signals respectively responsive to the first and second waveforms; and
generating comprises generating the two response waveforms, one from each of the signals.

4. A method according to claim 3 wherein the first and second waveforms are supplied sequentially.

5. A method according to claim 1 wherein at least one of the at least one voltage waveforms comprises a voltage having a plurality of distinct frequency components.

6. A method according to claim 3 wherein each of the at least one voltage waveforms comprises one or more voltage pulses.

7. A method according to claim 6 wherein each of said at least one first voltage wave forms has a duty cycle of less than 30%.

8. A method according to claim 3 wherein each of the at least one signals comprises a voltage between the probe and an electrode contacting soft tissue in the mouth.

9. A method according to claim 1 wherein both of the response waveforms have at least a primary frequency component and a substantial amount of at least one additional non-zero frequency component, where the primary frequency is different for the two waveforms.

10. A method according to claim 1 wherein the at least one other frequency component has an amplitude at least 10% of that of the primary frequency component.

11. (canceled)

12. A method according to claim 10 wherein the amplitude is at least 30% of that of the primary frequency.

13. (canceled)

14. A method according to claim 1 wherein estimating comprises:
deriving a characteristic value from each of the two response waveforms; and
estimating the distance of the probe from the apex utilizing the derived characteristic values of both response waveforms.

15. A method according to claim 14 wherein deriving a characteristic value of each of the two response waveforms comprises:
sampling the each of the response waveforms; and
summing the amplitude of the samples.

16. A method according to claim 14 wherein deriving a characteristic value of each of the two response waveforms comprises:
sampling the each of the response waveforms; and
summing the square of the amplitude of the samples.

17-18. (canceled)

19. A method according to claim 14 and comprising filtering one or both of the response waveforms wherein filtering comprises reducing the amplitude of one or more frequency components of the respective response waveform.

20. A method according to claim 14 and comprising filtering one or both of the response waveforms wherein filtering comprises decreasing the amplitude of the primary such that the relative amplitude of one or more other non-DC harmonics is increased when compared to that of the primary.

21-22. (canceled)

23. A method according to claim 14 and including finding an indicative value comprising finding a ratio between the two characteristic values.

24. A method according to claim 23 wherein estimating comprises comparing the indicative value to values derived from actual measurements on patients.

25-26. (canceled)

27. Apparatus for measuring the distance of a probe in a cavity in a root canal of a tooth, comprising:
a probe for insertion into a tooth;
an electrode for touching a soft tissue in the mouth;
a power supply supplying at least one voltage waveform to the probe via a resistor;
a controller that is operative to
receive the at least one signal responsive to the position of the probe and the at least one voltage waveform;
generate two response waveforms from said at least one signal, at least one of said response waveforms having at least a primary frequency component and a substantial amount of at least one other non-DC frequency component; and
estimate the distance of the probe from the apex utilizing both generated waveforms.

28. Apparatus according to claim 27 wherein the at least one voltage waveform comprises first and second voltage waveforms applied sequentially, wherein said at least one signal comprises first and second signals responsive to the first and second waveforms respectively.

29-30. (canceled)

31. Apparatus according to claim 27 wherein the at least one voltage waveform comprises a voltage having a plurality of distinct frequency components.

32. Apparatus according to any claim 28 wherein each of the at least one voltage waveforms comprises one or more voltage pulses.

33. (canceled)

34. Apparatus according to claim 27 wherein each of the at least one signals comprises a voltage between the probe and the electrode.

35. Apparatus according to claim 27 wherein both of the response waveforms have at least a primary frequency component and a substantial amount of at least one other non-DC frequency component, where the primary frequency is different for the two waveforms.

36-51. (canceled)
